(19) United States
(12) Patent Application Publication
(10) Pub. No.: US 2009/0046546 A1
(43) Pub. Date: Feb. 19, 2009

(54) DRIVING DEVICE

(75) Inventors: Hiroyuki Matsumoto, Saitama (JP); Takeshi Matsumoto, Saitama (JP); Katsunori Tamamura, Saitama (JP); Takao Yoshida, Saitama (JP); Fumito Inaba, Saitama (JP); Makoto Ikehata, Saitama (JP)

Correspondence Address: SUGHRUE MION, PLLC, 2100 PENNSYLVANIA AVENUE, N.W., SUITE 800, WASHINGTON, DC, 20037, US

(73) Assignee: Pioneer Corporation, Meguro-ku, Tokyo (JP)

(21) Appl. No.: 11/909,680

(22) PCT Filed: Mar. 8, 2006
(86) PCT No.: PCT/JP2006/304448

§ 371 Date: Sep. 25, 2007

(30) Foreign Application Priority Data
Mar. 25, 2005 (JP) 2005-088975

(51) Int. Cl. G11B 17/22

(52) U.S. Cl. 369/30.78; G9B/17.054

(57) ABSTRACT

A controller 27 controls the driving member 2 to move the conveyer 23 as a second member to a target position of the receiving rack 10 as a first member in the other direction after moving the conveyer 23 over the target position when the conveyer 23 is moved in one direction to align the conveyer 23 with the target position. After the conveyer 23 is moved over the target position and when the conveyer 23 is moved in the other direction, the controller controls the conveyer 23 to move by a distance of a mechanical error at a time, and then to move intermittently to the target position for aligning the conveyer 23 with the target position.

### TECHNICAL FIELD

This invention relates to a driving device, in particular, for aligning a receiving member and a conveying member, receiving a conveyed object such as a recording medium in the receiving member from the conveying member, or taking the received object out of the receiving member to the conveying member.

### BACKGROUND

A conventional method for aligning with high accuracy in a driving device is described in Patent Document 1. In the Patent Document 1, as schematically shown in FIG. 1, the driving device includes: a rack 51 for receiving recording media 50; a driving motor 53 controlled by a controller 52; a conveyer 54 to be moved up and down by the driving motor 53; an actuator 55 having cam mechanisms 55a, 55b for moving the conveyer 54 by transferring the driving force of the driving motor 53 to the conveyer 54; a potentiometer 56 for detecting a height of the conveyer 54; and a spring 57 urging the conveyer 54 and the actuator 55 in a specific direction. A power supply voltage terminal Vcc and a ground terminal GND are respectively connected to both ends of the potentiometer 56. An end of the conveyer 54 is connected to a slider 56a of the potentiometer 56.

When a current position of the conveyer 54 is lower than a target position of the rack 51, the controller 52 controls the driving motor 53 so that the conveyer 54 is once moved over the target position, then moved down to the target position. Thus, in any cases that the conveyer 54 is lower than or higher than the target position, finally, the conveyer 54 is moved down to the target position. Thus, the actuator 55 for driving the conveyer 54 is moved to the target position in the specific direction. Resultingly, even when the rack 51 has a rattle or a play owing to a mechanical error with respect to the rack 51, the rack 51 is aligned to the target position with high accuracy.

Patent Document 1: Japanese published patent application No. 2000-215576

### DISCLOSURE OF THE INVENTION

### Problem to be Solved by the Invention

In the Patent Document 1, when the conveyer 54 is lower than the target position, according to a divisional voltage V_{R} generated at the slider 56a of the potentiometer 56, the controller 52 once moves up the conveyer 54 to a position over the target position, and then moves the conveyer 54 down to the target position. When moving the conveyer 54 down, the controller 52 outputs a fine square wave to the driving motor 53 to reverse a direction of rotation of the driving motor 53 in a short time, judges whether the conveyer 54 is at the target position or not, and if the conveyer 54 is not at the target position, the controller 52 repeatedly outputs the square wave to reverse the direction of rotation of the driving motor 53 in a short time.

According to this method, if the rattle or the play as the mechanical error of the actuator 55 is large, when the moving direction of the conveyer 54 is changed from upward to downward, the conveyer 54 and the slider 56a is not moved until the motor 53 moves over a distance of the play or the rattle. Therefore, time for aligning the conveyer 54 to the target position may be increased.

Further, even if outputting the square wave having a predetermined width for absorbing the mechanical rattle or the play, because the mechanical rattle or the play may be varied owing to a productive variation of the driving device or a change of operating environment, the conveyer 54 may be under or over the target position.

Accordingly, an object of the present invention is to provide a driving device to be able to rapidly align a first member with a second member with high accuracy even when a mechanical error thereof is large and the error is varied owing to the productive variation or a change of operating environment.

### Means for Solving Problem

For attaining the object, according to the invention claimed in claim 1, there is provided a driving device including:

a first member;

a second member movable to the first member in both one direction and the other direction which is a reverse direction against the one direction;

a driving member to move the second member; and

a controlling member to control the driving member to move the second member to a target position of the first member in the other direction after moving the second member over the target position when the second member is moved in the one direction to align the second member with the target position, and to control the driving member to move the second member to the target position without moving over the target position when the second member is moved in the other direction to align the second member with the target position,

wherein after the second member is moved over the target position and when the second member is moved in the other direction, the controller controls the second member to move by a distance of a mechanical error at a time, and then to move intermittently to the target position for aligning the second member with the target position.

### BRIEF DESCRIPTION OF DRAWINGS

FIG. 1 is a schematic view showing a conventional driving device;

FIG. 2 is an exploded perspective view showing a structure of an on-vehicle player having a driving device according to the present invention;

FIG. 3 is another exploded perspective view showing the structure of the driving device shown in FIG. 2;

FIG. 4 is a perspective view showing a structure of a receiving rack of the driving device shown in FIG. 2;

FIG. 5 is a schematic view showing the driving device shown in FIG. 2;

FIG. 6 is a side view for explaining a transporting principle in the driving device shown in FIG. 2;

FIG. 7 is a side view for further explaining the transporting principle;

FIG. 8 is a side view for further explaining the transporting principle;

FIG. 9 is a flowchart for explaining an operation of the driving device shown in FIG. 2;

FIG. 10 is a flowchart for explaining an operation of a first transfer process of the driving device shown in FIG. 2;

FIG. 11 is a waveform chart of a driving signal to be supplied to a driving motor at the first transfer process of the driving device shown in FIG. 2;

FIG. 12 is an operating characteristic curve showing an operation characteristic of a conveyer at the first transfer process of the driving device shown in FIG. 2;

FIG. 13 is a flowchart for explaining an operation of moving a mechanical error margin at the first transfer process of the driving device shown in FIG. 2;

FIG. 14 is a flowchart for explaining an operation of a second transfer process of the driving device shown in FIG. 2;

FIG. 15 is a waveform chart of the driving signal to be supplied to the driving motor at the second transfer process of the driving device shown in FIG. 2;

FIG. 16 is an operating characteristic curve showing an operation characteristic of the conveyer at the second transfer process of the driving device shown in FIG. 2;

FIG. 17 is a flowchart for explaining a fine adjustment operation at the first and the second transfer processes of the driving device shown in FIG. 2;

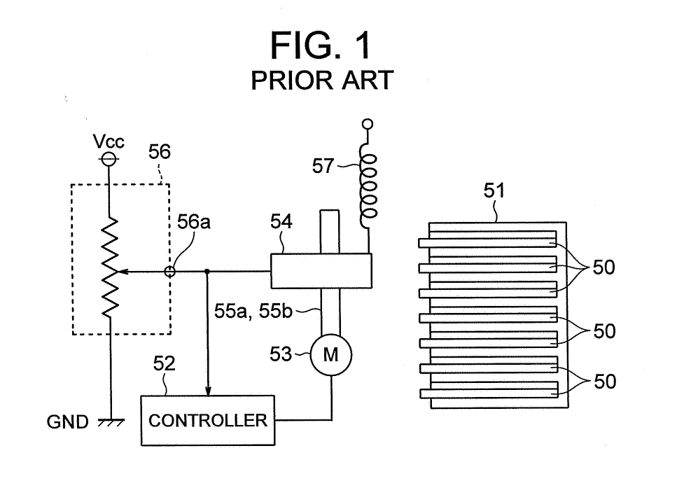

### EXPLANATIONS OF LETTERS OR NUMERALS

1 driving device
2 driving member
3 driving mechanism
8 on-vehicle player (electronic component)
9 base
10 receiving rack (first member)
13 first cam member
15 second cam member
17 lever member
18 driving motor
19 spring
20 gear mechanism
23 conveyer (second member)
24 potentiometer (detecting member)
24a slider
27 controller (controlling member)
Vg divisional voltage

### BEST MODE FOR CARRYING OUT THE INVENTION

Hereunder an embodiment of the present invention will be explained. A driving device according to the embodiment of the present invention moves a second member by a distance of a mechanical error of the second member against a first member at a time when the second member is aligned with the first member. Thus, the alignment is rapidly done with high accuracy even when the distance of the mechanical error is large, and varied owing to a productive variation or a change of operating environment.

Further, the driving device may include a detecting member for detecting a position of the second member relative to the first member. A control member of the driving device may control a driving member of the driving device according to data indicating the position of the second member detected by the detecting member.

Further, the control member may move the second member by the distance of the mechanical error at a time in a manner that after the second member is moved over a target position, the driving member is continuously operated until the data indicating the position of the second member detected by the detecting member is varied over a specific value.

Further, an electronic component may include the driving device of the present invention.

### FIRST EMBODIMENT

Hereunder, as an embodiment according to the present invention, a driving device mounted on an on-vehicle player as an electronic component using recording media such as CD (Compact Disc) and DVD (Digital Versatile Disc) will be explained.

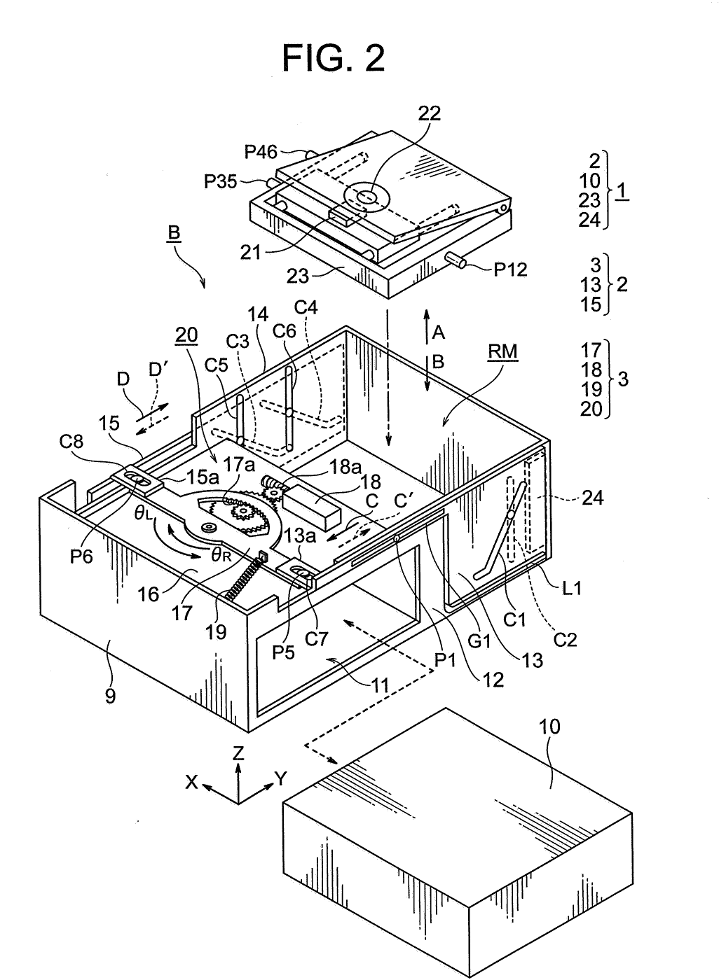

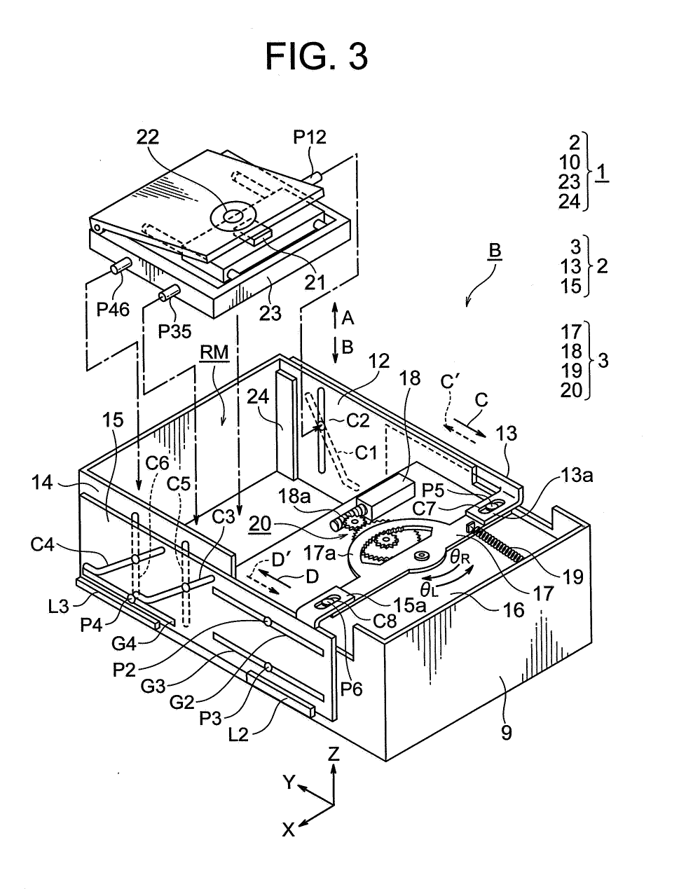

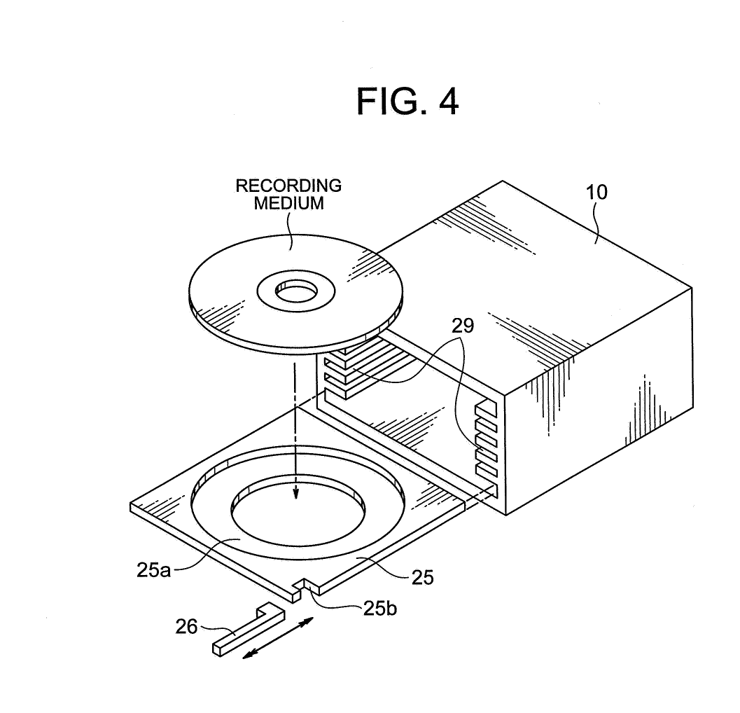

FIGS. 2 and 3 are exploded perspective views showing a main structure of the on-vehicle player, and FIG. 4 is a perspective view showing a structure of a cartridge type receiving rack as a first member mounted on the on-vehicle player. FIG. 2 is the perspective view to be seen from an operation panel side of the on-vehicle player. FIG. 3 is the perspective view to be seen from a rear side of the on-vehicle player. Rectangular coordinates XYZ indicate a horizontal plane direction and a height direction.

As shown in FIG. 2, an insertion hole 11 for inserting detachably a box-shaped receiving rack 10 as the first member along an X-axis direction (a depth direction) is formed at an operation panel side of a box-shaped base 9 composing a chassis of an on-vehicle player 8 as an electronic component.

A substantially L-shaped first cam member 13 is mounted on a sidewall 12 at the operation panel side of the base 9. A substantially L-shaped second cam member 15 is mounted on a sidewall 14 at a rear side of the base 9.

A guiding groove G1 extending in a Y-axis direction and a slim cam groove C1 sloped at a specific angle are drilled on the first cam member 13. Because a fitting projection projected on one side of the sidewall 12 is slidably fitted into the guiding groove G1, and the first cam member 13 is slidably supported by a guiding rail L1 formed under the sidewall 12, the first cam member 13 is allowed to be moved back and forth in the Y-axis direction (a width direction).

Further, a slim cam groove C2 crossing the cam groove C1 formed on the first cam member 13, and extending in a Z-axis direction (a thickness direction) is drilled on the sidewall 12.

As shown in FIG. 3, guiding slits G2, G3, G4 extending in the Y-axis direction and slim cam grooves C3, C4 sloped at a specific angle are drilled on the second cam member 15. Because fitting projections P2, P3, P4 projected on one side of the sidewall 14 are slidably fitted into the guiding grooves G2, G3, G4, and the second cam member 15 is slidably supported by guiding rails L2, L3 formed under the sidewall 14, the second cam member 15 is allowed to be moved back and forth in the Y-axis direction.

Further, a slim cam groove C5 crossing the cam groove C3 formed on the first cam member 15, extending in the Z-axis direction, and a slim cam groove C6 crossing the cam groove C4 and extending in the Z-axis direction are drilled on the sidewall 14.

All of a crossing angle between the cam groove C1 and the cam groove C2, a crossing angle between the cam groove C3 and the cam groove C5, and a crossing angle between the cam groove C4 and the cam groove C6 are the same. The cam groove C1 and the cam grooves C3, C4 are sloped opposite to each other.

A top wall 16 disposed over the insertion hole 11 is mounted in the base 9. A driving mechanism 3 for moving back and forth the first and second cam members 13, 15 in the Y-axis direction is mounted on the top wall 16. The driving mechanism 3 includes: a rotatably supported lever member 17; a driving motor 18; a spring 19 for constantly pulling the lever member 17 in a clockwise direction with a specific resiliency; and a gear mechanism 20 for transmitting a driving force of the driving motor 18 to the lever member 17. Further, the gear mechanism 20 includes: a screw gear 18a connected to a driving shaft of the driving motor 18; a gear portion 17a formed at an end of the lever member 17; and a plurality of gears meshing with the gears 18a, 17a.

These first and second cam members 13, 15 compose a driving member 2 for driving a conveyer 23 as the second member.

Tongue portions 13a, 16a having cam holes C7, C8 are respectively formed on the first and the second cam members 13, 15. Fitting projections P5, P6 formed on both ends of the lever member 17 are fitted into the cam holes C7, C8.

When the lever member 17 is rotated in the clockwise direction θ_{R} (a direction pulled by the spring 19) by the driving force of the driving motor 18, in proportion to an amount of rotation, the first cam member 13 is moved in the direction pulled by the spring 19 (indicated by an arrow C), and the second cam member 15 is moved in a reverse direction (indicated by an arrow D).

When the lever member 17 is rotated in a counterclockwise direction θ_{L} by the driving force of the driving motor 18, in proportion to the amount of rotation, the first cam member 13 is moved in a direction of an arrow C′ opposed to the direction of the arrow C, and the second cam member 15 is moved in a direction of an arrow D opposed to the direction of the arrow D.

The conveyer 23 as the second member having a pickup 21 for optically reading recorded data recorded in a recording medium such as CD or DVD, and a clamping mechanism 22 for clamping the recording medium is arranged in a room RM next to the insertion hole 11 in the base 9.

Guiding projections P12, P35, P46 are projected from both ends of the conveyer 23 as the second member. The guiding projection 12 is fitted into a crossing part between the cam grooves C1 and C2. The guiding projection 35 is fitted into a crossing part between the cam grooves C3 and C5. The guiding projection 64 is fitted into a crossing part between the cam grooves C4 and C6.

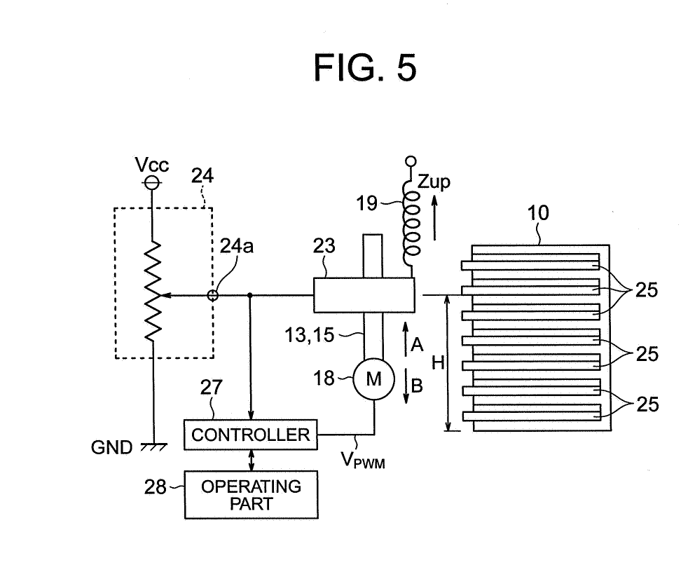

A potentiometer 24 as a detecting member DC biased by a specific voltage is arranged in the base 9. A slider 24a (See FIG. 5) of the potentiometer 24 is connected to an end of the conveyer 23. The potentiometer 24 detects a position of the conveyer 23 relative to the receiving rack 10 from a divisional voltage V_{R} generated at the slider 24a, and outputs data indicating the position of the conveyer 23 relative to the receiving rack 10 to a controller 27.

In FIG. 4, a plurality of receiving slots 29 is formed in the receiving rack 10 as the first member. Each receiving slot 29 detachably receives a tray 25. A circular recess 25a on which the recording medium such as CD and DVD is placed, and a notch 25b are formed on the tray 25. The receiving rack 10 is inserted into the insertion hole 11 in a manner that the trays 25 are received in the receiving slots 29, and an opening of the receiving rack 10 faces the conveyer 23.

Thus, when the receiving rack 10 as the first member is inserted into the insertion hole 11, each tray 25 faces the conveyer 23 as the second member. The conveyer 23 is moved to a target position in the Z-axis direction. Then, an engaging lever 26 operated by an actuator (not shown) mounted on the conveyer 23 engages with the notch 25b of the tray 25 at the target position, and moves in a direction away from the receiving rack 10 to align with the tray 25. Then, the engaging lever 26 pulls the tray 25 to the clamping mechanism 22, and the recording medium is clamped. Then, the clamping mechanism 22 rotates the recording medium, and the pickup 21 reads the data recorded in the recording media. Thus, the data is reproduced.

Thus, the conveyer 23 is movable relative to the receiving rack 10 in one direction parallel to the Z-axis, and the other direction opposite to the one direction.

Various members of the driving member 2 include rattles and plays. Therefore, the conveyer 23 has a mechanical error relative to the receiving rack 10. Owing to the mechanical error, there is an area where the conveyer 23 is not moved even when the driving motor 18 is rotated. Namely, the mechanical error means the area where the conveyer 23 is not moved even when the driving motor 18 is rotated.

When the engaging lever 26 is engaged with the notch 25b of the tray 25 at the clamping position, and moved toward the receiving slot 29 at the target position, the receiving slot 29 at the target position receives the tray 25.

A driving device 1 includes: the receiving rack 10 as the first member; the conveyer 23 as the second member; the potentiometer 24 as the detecting member; and the controller 27 as the controlling member.

Next, as shown in FIGS. 5 to 8, a basic operation of the driving device 1 for moving the conveyer 23 in the Z-axis direction of FIGS. 2 to 3 will be explained. Arrows A, B in FIGS. 2 to 8 are parallel to the Z-axis, and the arrow A indicates one direction, the arrow B indicates the other direction opposed to the one direction. FIG. 5 is a schematic view showing the typical driving device 1. In FIG. 5, guide projections P12, P35, P46 projected from both ends of the conveyer 23 are fitted into the crossing parts between the cam grooves C1, C3, C4 and the cam grooves C2, C5, C6, so that the conveyer 23 is supported by the cam members 13, 15. These cam members 13, 15 are moved back and force by the driving force of the driving motor 18. Following this movement, positions of the crossing parts between the cam grooves C1, C3, C4 and the cam grooves C2, C5, C6 are relatively shifted, and resultingly a height H of the conveyer 23 is changed. Further, a position where the conveyer 23 faces the receiving slot 29 formed on the receiving rack 10 is changed.

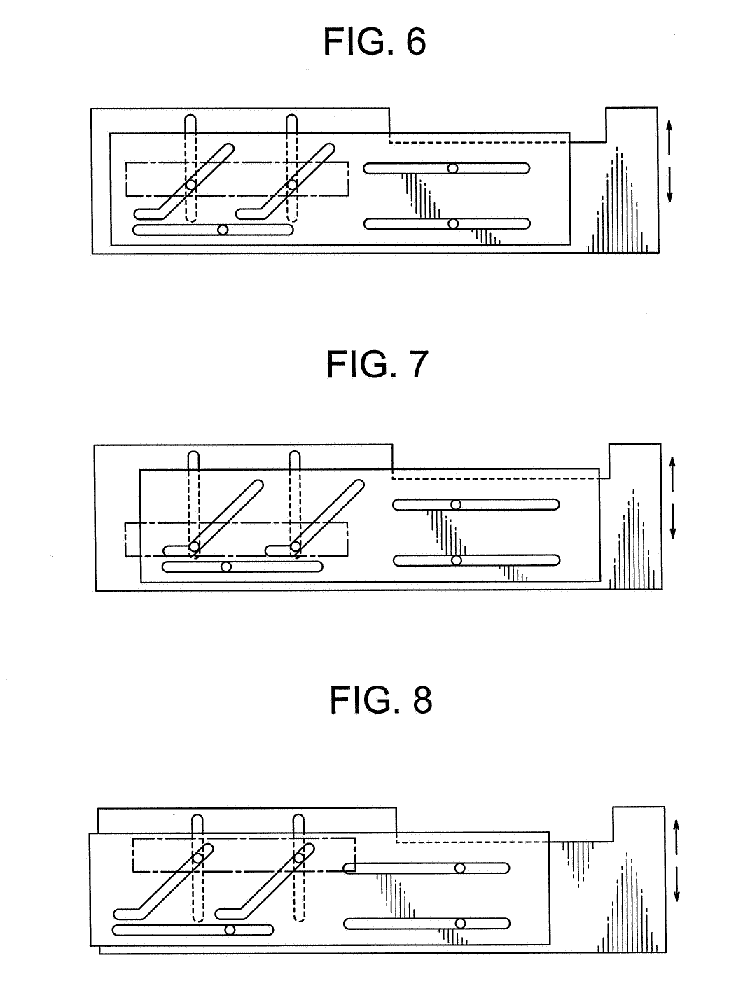

Namely, as shown in side views of FIGS. 6 to 8, when the second cam member 15 is moved toward the receiving rack 10 (a direction of the arrow D′), the positions of the crossing parts between the cam grooves C5, C6 and the cam grooves C3, C4 are moved in a direction of an arrow B, and resultingly, the guiding projections P35, P46 are moved in the direction of the arrow B. Therefore, the conveyer 23 is moved in the direction of the arrow B. When the second cam member 15 is moved away from the receiving rack 10 (a direction of the arrow D), the positions of the crossing parts between the cam grooves C5, C6 and the cam grooves C3, C4 are moved in a direction of an arrow A, and resultingly, the guiding projections P35, P46 are moved in the direction of the arrow A. Therefore, the conveyer 23 is moved in the direction of the arrow A. Incidentally, the crossing part between the cam grooves C2 and C1 is also moved in the direction of the arrows A, B following the movement of the first cam member 13. Therefore, the conveyer 23 is moved along the arrows A, B owing to the movements of the cam members 13, 15 of which directions are opposite to each other.

Again in FIG. 5, a controller 27 for controlling a direction of rotation and an amount of rotation of the driving motor 18, and an operating part 28 where a user instructs desired instructions to the controller 27 are mounted on the driving device 1. The controller 27 includes a microprocessor for controlling the driving motor 18 with an execution of a predetermined system program.

This microprocessor inputs the divisional voltage V_{R} generated at the slider 24a of the potentiometer 24 connected to an end of the conveyer 23 through an A/D converter (not-shown), and detects a current height H of the conveyer 23 based on a voltage level of the divisional voltage V_{R}. When moving the conveyer 23 to the target point, this microprocessor supplies the pulse-width modulated driving voltage V_{PWM} to the driving motor 18 to control the direction of rotation and the amount of rotation of the driving motor 18. Incidentally, the potentiometer 24 is DC biased in a manner that both ends of the potentiometer 24 are respectively connected to a power source terminal Vcc and a ground terminal GND.

As shown in FIGS. 2 and 3, the spring 19 pulls the lever member 17 in a specific direction. Therefore, as schematically shown in FIG. 5, the cam members 13, 15 and the gear mechanism 20 arranged between the driving motor 18 and the conveyer 23 are constantly pulled by the spring 19. In this embodiment, the conveyer 23 is constantly pulled in a direction Zup of the arrow A.

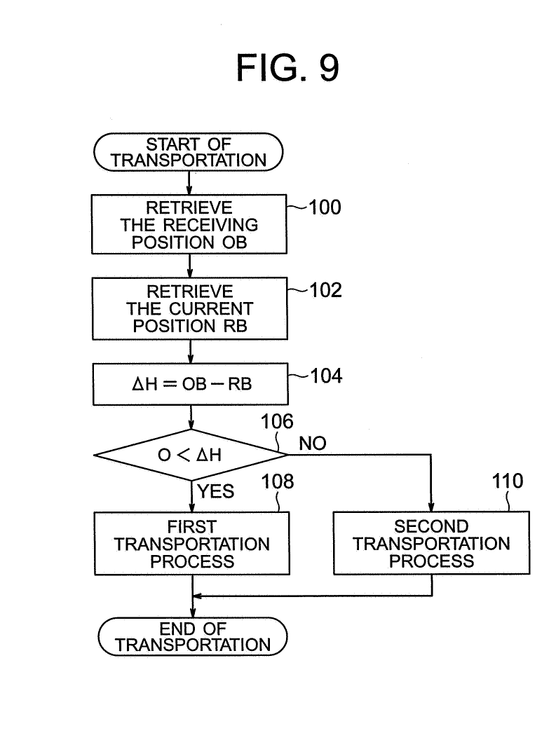

Next, an example of a concrete operation of the driving device 1 having the structure described above will be explained with reference to FIGS. 9 to 16.

In FIG. 9, when a user instructs a playback of a desired recording medium, a transportation process begins. Firstly, a receiving position OB of the tray 25 receiving the desired recording medium is retrieved from a memory (not-shown) of the microprocessor (step 100). Then, a current position RB of the conveyer 23 is detected based on the divisional voltage V_{R} (step 102).

Next, a difference ΔH between the receiving position (hereafter referred to as the target position) OB and the current position RB is calculated as a distance to be moved (step 104). Next, whether the difference ΔH is a positive number or not is judged at step 106 as the judging member. When the difference ΔH is positive (“YES”), the process goes to a first transportation process (step 108) for moving the conveyer 23 from the current position RB in the direction of the arrow A. When the difference ΔH is negative (“NO”), the process goes to a second transportation process (step 110) for moving the conveyer 23 from the current position RB in the direction of the arrow B. After the first or the second transportation process is finished, the tray 25 received in the target position OB is pulled out from the receiving rack 10, and the clamping mechanism 22 of the conveyer 23 clamps the recording medium mounted on the tray 25, so that the data is reproduced with the pickup 21.

When the reproduced recording medium is received in the receiving slot 29, a similar transportation process is performed.

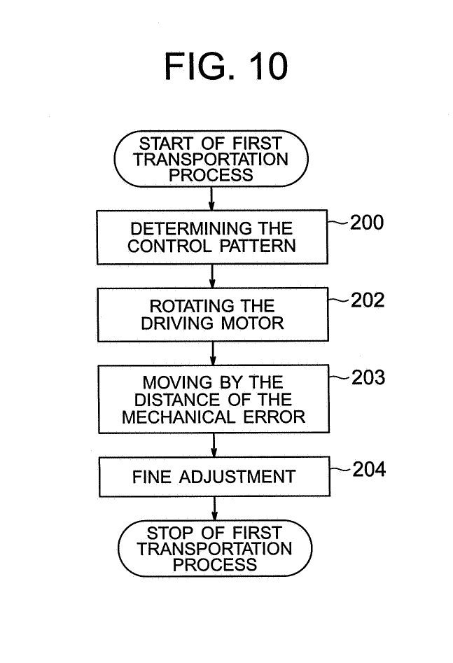

The first transportation process (step 108) is performed according to a flowchart shown in FIG. 10. First, in step 200, according to an absolute value of the difference |ΔH|, a control pattern of the driving voltage V_{PWM} to be supplied to the driving motor 18 is determined.

Namely, in this embodiment, the conveyer 23 is moved acceleratedly from an initial movement in a specific period τ1 (a first control mode), then moved deceleratedly to a position near the target position OB in a next period τ2 (a second control mode), and then finely adjusted (a third control mode), so that the conveyer 23 is moved intermittently to be aligned with the target position OB with very high accuracy. Further, the periods τ1, τ2 are adjusted corresponding to the distance |ΔH| between the current position RB and the target position OB, so that the conveyer 23 is moved rapidly with high accuracy. Further, in the first transportation process, because the distance of the mechanical error is moved at a time (a fourth control mode) between the second and the third control modes, the conveyer 23 is further rapidly moved than a conventional transportation.

Incidentally, the periods τ1, τ2 are determined by retrieving from a look-up table in which the periods τ1, τ2 corresponding to the distance |ΔH| are previously stored, or by assigning the distance |ΔH| to a function which is previously determined and expresses a relationship between the distance |ΔH| and the periods τ1, τ2.

Next, in step 202, by supplying the driving voltage V_{PWM} to the driving motor 18, the conveyer 23 is moved to the target position OB.

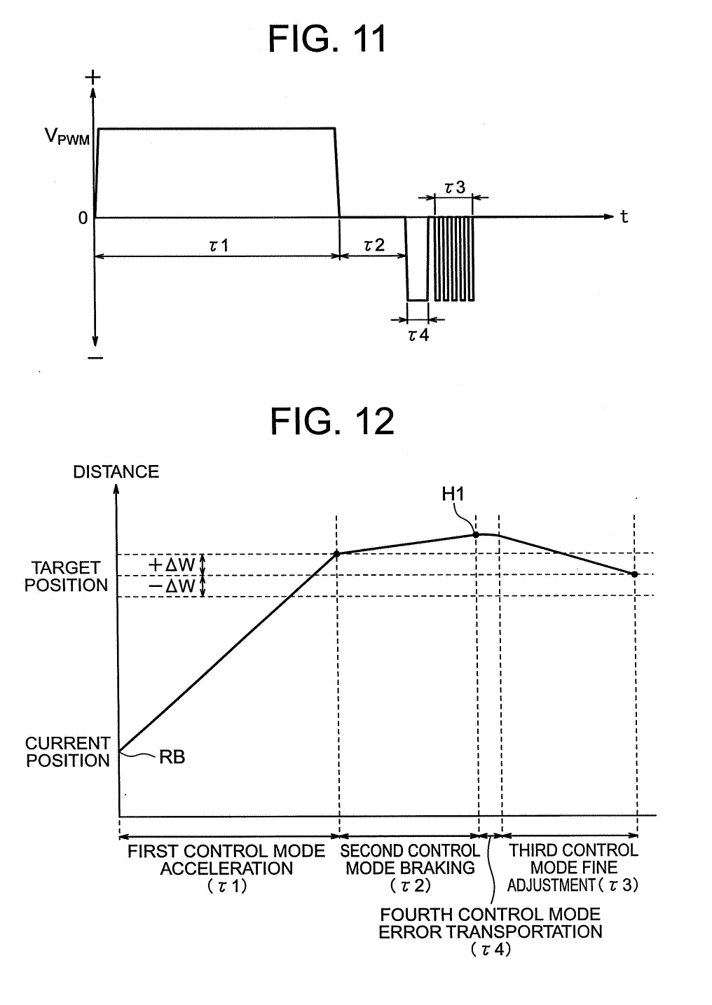

As shown in a waveform chart of FIG. 11, in the period ˜1 of the first control mode, the conveyer 23 is accelerated by the DC driving voltage VPWM having specific amplitude. Further, a moving position of the conveyer 23 is minutely detected based on the divisional voltage V_{R} generated at the potentiometer 24. When the conveyer 23 is over a tolerance ±ΔW around the target position OB, the process is changed to the second control mode. In the period τ2 of the second control mode, the driving motor 18 is braked with the driving voltage V_{PWM} having zero volt, and the speed of the conveyer 23 is reduced. Thus, as shown in the operating characteristic curve of FIG. 12, after performing the first and the second control modes, the conveyer 23 is moved to a position H1 which is a little bit over the target position OB.

Next, in step 203, the process is changed to the fourth control mode, and the conveyer 23 is moved by the distance of rattle and play as the mechanical error of the cam members and the lever member. As shown in FIG. 11, from the period τ4 of the fourth control mode, a polarity of the driving voltage V_{PWM} is reversed. Accordingly, the driving motor 18 is reversely rotated, but until the conveyer 23 is moved by the distance of the rattle and the play of the cam members 13, 15 and the gear mechanism 20, the conveyer 23 is not moved from the height H1.

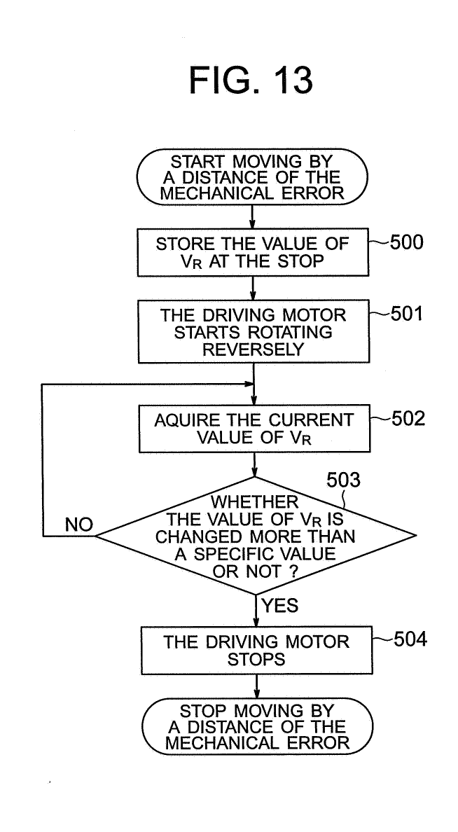

The movement of the mechanical error in step 203 is performed according to a flowchart of FIG. 13. Firstly, in step 500, the microprocessor stores the divisional voltage V_{R} generated at the slider 24a of the potentiometer 24 at the position of the height H1 where the conveyer 23 is stopped.

Next, in step 501, the driving motor 18 is reversely rotated with the negative biased driving voltage V_{PWM}. At this time, because there is the mechanical error as rattles and plays of the cam members 13, 15 and the gear mechanisms 20, the conveyer 23 is not moved along the arrow B. Accordingly, the level of the divisional voltage V_{R} is not changed.

Next, in step 502, the microprocessor inputs the divisional voltage V_{R} generated at the slider 24a of the potentiometer 24. At this time, because the driving voltage V_{PWM} is constantly supplied, the driving motor 18 is constantly rotated.

Next, in step 503, the microprocessor compares the level of the divisional voltage V_{R} stored in step 500 with that stored in the step 502, and judges whether the divisional voltage V_{R} is changed over a predetermined level or not. If the driving motor 18 is rotated to move the conveyer 23 by the distance f the rattles and the plays of the cam members 13, 14 and the gear mechanism 20, the conveyer 23 begins to move, and the slider 24a of the potentiometer 24 begins to move. In this case, the level of the divisional voltage V_{R} in step 502 is changed from the level of the divisional voltage V_{R} stored in step 500. If the level of the divisional voltage V_{R} is not changed over the specific level (“NO” in step 503), the microprocessor judges that the movement of the distance of the rattles and the plays is not finished, and the process goes back to step 502 to input again the level of the divisional voltage V_{R}.

Next, when the level of the divisional voltage V_{R} (data indicating the position of the conveyer 23 relative to the receiving rack 10) is over the specific level (“YES” in step 503), the microprocessor judges that the movement of the distance of the rattles and the plays is finished, and brakes the driving motor 18 by stopping a supply of the driving voltage V_{PWM} in step 504.

Thus, in the movement of the distance of the mechanical error (step 203), when the conveyer 23 is reversely moved from the position H1 to the target position OB, the driving motor 18 is constantly rotated until detecting the level of the divisional voltage V_{R} which is over the specific level. Thus, the distance of the rattles and the plays of the cam members 13, 15 and the gear mechanism 20 is moved with a single pulse.

Further, in step 203, the conveyer 23 is moved while detecting the actual mechanical error. Therefore, even when the mechanical error is changed by the change of an environmental temperature or by a productive variation, the variation is compensated. Therefore, the driving device 1 can move the conveyer 23 to the target position OB more rapidly than a conventional driving device. In particular, because an on-vehicle player is naturally used under an environment having a large temperature change, an effect of the process in step 203 is extremely large.

Next, as shown in FIG. 10 again, the process changes to the third control mode and a fine adjustment is performed. As shown in FIG. 11, in a period ˜3 of the third control mode, the driving pulse V_{PWM} is set to be square wave pulses. Thus, the conveyer 23 is intermittently moved along the arrow B from the height H1 toward the target point OB with an extremely small resolution. Then, based on the divisional voltage V_{R} generated at the potentiometer 24, the moving position of the conveyer 23 is minutely detected. As shown in FIG. 12, when the conveyer 23 is arrived at a tolerance range ±ΔW around the target position OB, the supply of the driving voltage V_{PWM} is stopped to stop the conveyer 23, and the first transportation process is ended.

Thus, in the first transportation process (step 108), the conveyer 23 is once moved over the target position OB along the arrow A, then moved by the distance of the mechanical error, and then moved to the target position OB along the arrow B with such a fine adjustment.

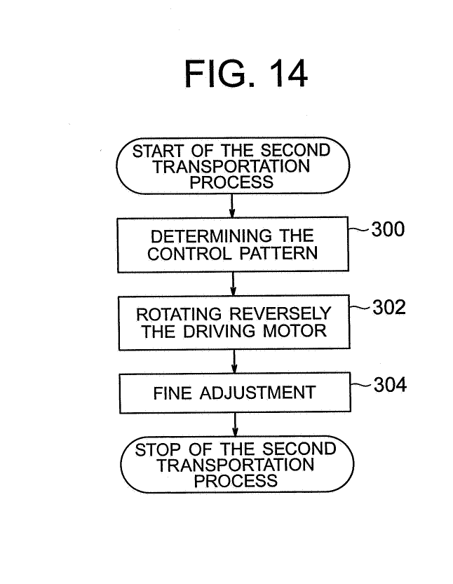

Next, a second transportation process (step 110) as shown in FIG. 9 is performed according to a flowchart of FIG. 14. First, in step 300, based on the distance |ΔH|, a control pattern of the driving voltage V_{PWM} to be supplied to the driving motor 18 is determined.

Namely, even when the conveyer 23 is moved toward the target position OB along the arrow B, the similar first to third control modes are set, and the waveform of the driving voltage V_{WPM} is adjusted in each control mode. Then, the periods τ1, τ2 are determined by retrieving from a look-up table in which the periods τ1, τ2 corresponding to the distance |ΔH| are previously stored, or by assigning the distance |ΔH| to a function which is previously determined and expresses a relationship between the distance |ΔH| and the periods τ1, τ2.

Next in step 302, by supplying the driving voltage V_{PWM} to the driving motor 18, the driving motor 18 is reversely rotated, and the conveyer 23 is moved down toward the target position OB.

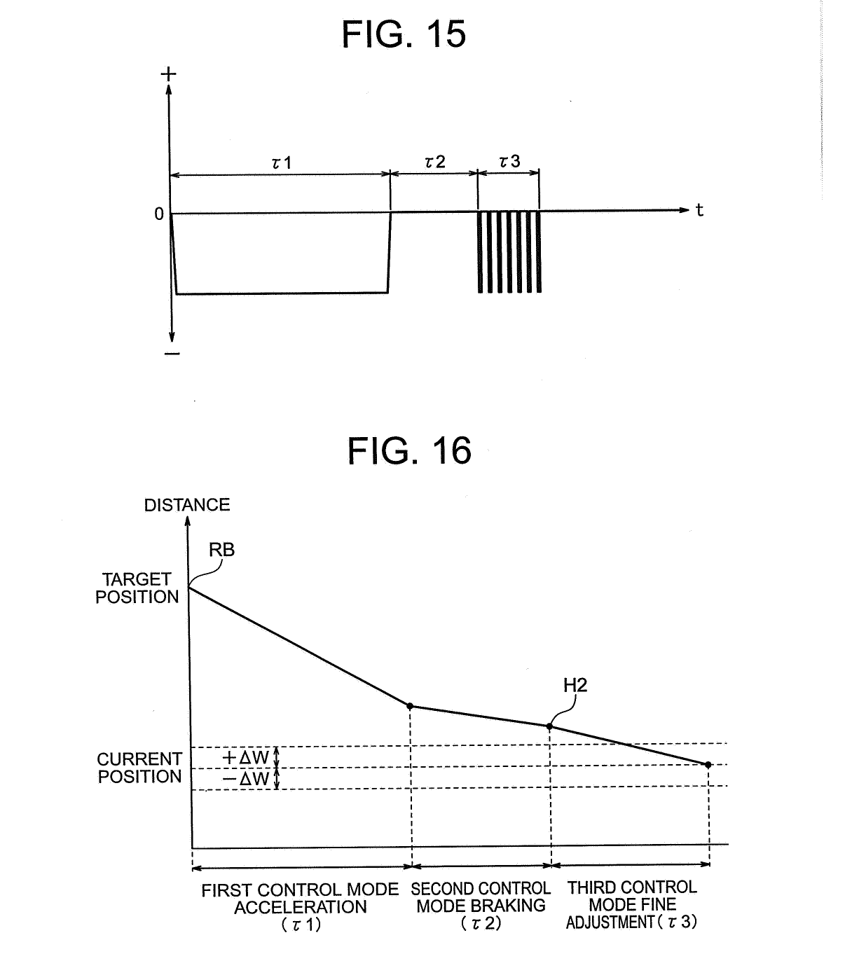

As shown in FIG. 15, in the period τ1 of the first control mode, the conveyer 23 is accelerated by setting the driving voltage V_{PWM} as a negative DC voltage with a specific width. Further, based on the divisional voltage V_{R} generated at the potentiometer 24, the moving position of the conveyer 23 is minutely detected. When the conveyer 23 is arrived at a position near the target position OB, the process is changed to the second control mode. In the period τ2 of the second control mode, the driving motor 18 is braked with the driving voltage V_{PWM} having zero volt, and the speed of the conveyer 23 is reduced. As shown in an operating characteristic curve of FIG. 16, due to the first and the second control modes, the conveyer 23 is moved to a position H2 slightly ahead of the target position OB.

Next, in step 304, the process is changed to the third control mode, and a fine adjustment is performed. As shown in FIG. 15, in the period τ3 of the third control mode, the polarity of the driving voltage V_{PWM} is set to negative square wave pulses. Thus, the driving motor 18 is reversely rotated again, and the conveyer 23 is intermittently moved along the arrow B from the height H2 toward the target point OB with an extremely small resolution.

Then, based on the divisional voltage V_{R} generated at the potentiometer 24, the moving position of the conveyer 23 is minutely detected. As shown in FIG. 16, when the conveyer 23 is arrived at a tolerance range ±ΔW around the target position OB, the supply of the driving voltage V_{PWM} is stopped to stop the conveyer 23, and the transportation process is ended.

Thus, in the second transportation process (step 110), the conveyer 23 is moved to the target point with high accuracy by continuously moving the conveyer 23 along the arrow B until the conveyer 23 is arrived at the target point OB.

According to this embodiment describing the above, the controller 27 controls to move the conveyer 23 to the position H1 over the target position OB. Then, when moving the conveyer 23 toward the target position OB along the arrow B, only one square wave pulse is supplied to the driving motor 18 to continuously move the conveyer 23 for absorbing the mechanical error until the divisional voltage V_{R} is changed over a predetermined level. Thus, the conveyer 23 of the driving device 1 is aligned faster than that of the conventional device.

Resultingly, the conveyer 23 of the driving device 1 is aligned with the tray 25 received in the receiving rack 10 faster than that of the conventional device. Therefore, the tray 25 and the recording medium can be smoothly pulled out of the receiving rack 10, and pulled into the receiving rack 10.

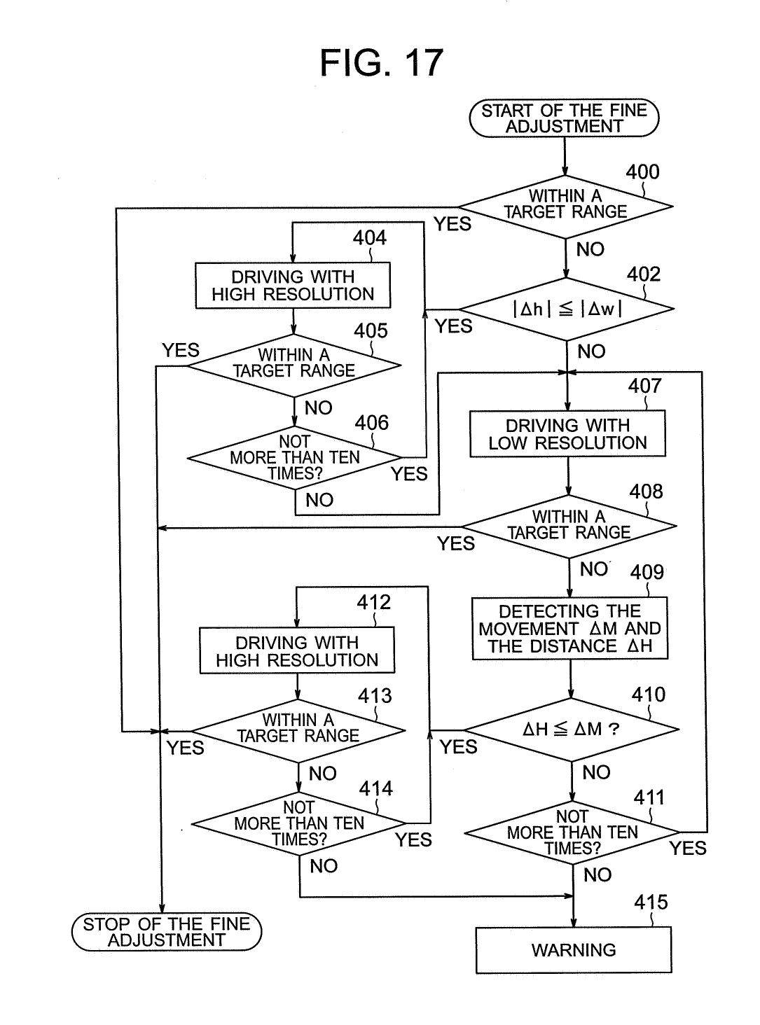

Incidentally, in the fine adjustment described the above, according to the flowchart of FIG. 17, a more precisely fine adjustment can be made. The flowchart of FIG. 17 is used for both step 204 to move the conveyer 23 up to the target position OB disposed over the current position RB and step 304 to move the conveyer 23 down to the target position OB disposed under the current position RB.

When the process of step 204 or step 304 in FIG. 10 or FIG. 14 is started, then, in step 400 of FIG. 7, whether the conveyer 23 is already arrived at the tolerance range ±ΔW of the target position OB or not is judged. If the conveyer 23 is already arrived at the tolerance range ±ΔW of the target position OB, the fine adjustment is ended.

On the other hand, if the conveyer 23 is positioned out of the tolerance range ±ΔW of the target position OB, a difference (distance) Ah from the target position OB to the current position RB is calculated, and whether the difference Δh is smaller than a predetermined range Δw or not is judged. Incidentally, a relationship between an absolute value |Δw| and the absolute value |ΔW| of the tolerance range is |ΔW|<|Δw|.

When the difference |Δh| is lower than the range |Δw|, the process performs steps 404 to 406. In a very short time, the driving motor 18 is reversely rotated and braked with high resolution (step 404). Further, by minutely detecting the divisional voltage V_{R} of the potentiometer 24, whether the conveyer 23 is arrived at the tolerance range ±ΔW of the target position OB or not is judged (step 405). Then, until the conveyer 23 is arrived at the tolerance range ±ΔW of the target position OB, the process is repeated ten times at the maximum (step 406). When it is judged that the conveyer 23 is arrived at the tolerance range ±ΔW of the target position OB (step 405), the fine adjustment is ended.

On the other hand, it is judged that after the process is repeated ten times, the conveyer 23 is not arrived at the tolerance range ±ΔW of the target position OB (step 406), the process goes to step 407. Further, in step 407, when the difference Δh is larger than the range Δw, the process also goes to step 407.

In step 407, in a very short time, with lower resolution in step 407 than in steps 404 to 406, the driving motor 18 is reversely rotated and braked. Next, by minutely detecting the divisional voltage V_{R} of the potentiometer 24, whether the conveyer 23 is arrived at the tolerance range ±ΔW of the target position OB or not is judged (step 408). If the conveyer 23 is arrived at the tolerance range ±ΔW of the target position OB, the fine adjustment is ended.

On the other hand, in step 408, when the conveyer 23 is not arrived at the tolerance range ±ΔW of the target position OB, the process goes to step 409. In step 409, a distance (movement) ΔM where the conveyer 23 is moved in step 407 is detected based on the change of the divisional voltage V_{R}. Further, a distance ΔH between the current position of the conveyer 23 and the target position OB is detected based on the divisional voltage V_{R}.

Next, in step 410, whether the distance ΔM is larger than the distance ΔH or not is judged. If ΔH is larger than ΔM, a repeating number is checked in step 411, and the process repeats steps 407 to 410. Incidentally, in step 411, the process is set to be repeated ten times at the maximum.

When the distance ΔH is still larger than the distance ΔM after the process repeats steps 407 to 410 ten times, the process goes to step 415 from step 411, the controller judges that some trouble occurs, and stops the process. Then, a not-shown alarm lamp or the like is lighted to warn a user.

Alternately, in step 410, when it is judged that the distance ΔH is not larger than the distance ΔM, the process goes to steps 412 to 414. In steps 412 to 414, similar to steps 404 to 406, in a very short time, the driving motor 18 is reversely rotated and braked (step 412). Further, by minutely detecting the divisional voltage V_{R} of the potentiometer 24, whether the conveyer 23 is arrived at the tolerance range ±ΔW of the target position OB or not is judged (step 413). Then, the process repeats ten times at the maximum until the conveyer 23 is arrived at the tolerance range ±ΔW of the target position OB (step 414). When it is judged that the conveyer 23 is arrived at the tolerance range ±ΔW of the target position OB (step 413), the fine adjustment is ended. When it is judged that after the process repeats ten times, the conveyer 23 is not arrived at the tolerance range ±ΔW of the target position OB, the process goes to step 415, and the transportation process is stopped. Then, the warning lamp is lighted to warn the user.

Thus, the fine adjustment according to the flowchart of FIG. 17 allows the process to perform the first, second, and fourth control modes. Thus, the fine adjustment moves intermittently the conveyer 23 corresponding to the movement and position of the conveyer 23.

Namely, in steps 404 to 406, owing to the first, second, and fourth control modes, when the conveyer 23 is arrived at a position relatively near the target position OB, the fine adjustment is performed with high resolution.

Further, in steps 407 to 411, owing to the first, second, and fourth control modes, when the conveyer 23 is arrived at a position relatively away from the target position OB, the fine adjustment is performed with low resolution.

Further, when the conveyer 23 is arrived at a position relatively near the target position OB as a result of the transportation with low resolution in steps 407 to 411, the fine adjustment with high resolution is performed in steps 412 to 414 to move the conveyer 23 to the target position OB.

Incidentally, if the conveyer 23 is not arrived at the tolerance range ±ΔW of the target position OB after these fine adjustment, the process warn the user that the conveyer 23 cannot be moved with some trouble. Therefore, the on-vehicle player is prevented from being fatally broken. Incidentally, a repeating cycle in the fine adjustment is not limited to tem times. The number of the repeating cycle may be changed according to a characteristic of a device using the present invention.

In this embodiment, during the fine adjustment, the spring 19 urges all the components such as the cam members 13, 15 or the gear mechanism 20 for driving the conveyer 23. Resultingly, these components are biased in the urging direction while the conveyer 23 is moved along the arrow B. Therefore, even if mechanical errors such as a mechanical rattle or play exist in the cam members 13, 15 and the gear mechanism 20, a balance of the urging force of the spring 19 and the driving force of the driving motor 18 suppresses the mechanical errors. Therefore, the conveyer 23 can be aligned with the target position OB with high accuracy.

However, even if the spring 19 is not provided, by adjusting from one direction, the components of the cam members 13, 15, and the gear mechanism 20 for driving the conveyer 23 are inevitably biased to a specific direction, and the mechanical errors are practically suppressed. Therefore, it is not necessary to provide the spring 19.

If in the on-vehicle player 8 having a so-called automatic changer function without using the present invention, the conveyer 23 is moved along the arrow B to be aligned when the current position is over the target position, and moved along the arrow A to be aligned when the current position is under the target position, the divisional voltages V_{R} of the potentiometer 24 are different from each other. Namely, the actual position of the conveyer 23 is shifted between a case that the conveyer 23 is moved down to be aligned and a case that the conveyer 23 is moved up to be aligned. In this case, owing to this difference, the tray 25 may not pulled out from the receiving rack 10. In this embodiment, the on-vehicle player 8 includes the driving device 1 for preventing the difference from causing owing to high accuracy alignment. Namely, the driving device 1 of this invention is used in the on-vehicle player 8 of which mechanical error of the conveyer 23 is much larger than the alignment accuracy of the conveyer 23, and when the conveyer 23 is aligned from one direction and the other direction, detected values of the potentiometer 24 are different from each other. This invention is effective not only for the on-vehicle player 8, but also for other apparatuses which need high accuracy.

Incidentally, in this embodiment, the on-vehicle player 8 having a detachable receiving rack 10, and having the so-called automatic changer function is explained. However, the receiving rack 10 may be fixed in the base 9. Further, the on-vehicle player 8 in which the recording medium is pulled out from the receiving rack 10 is explained. However, the present invention is not limited to this. For example, the tray 25 in the receiving rack 10 may be detachable, and a player having a clamp mechanism may be inserted into the receiving rack 10 to play the recording medium. In this case, the conveyer 23 as the second member corresponds to the player mechanism. This player mechanism is driven by the driving member to be aligned with the tray 25 in the receiving rack 10.

Incidentally, in this embodiment, the conveyer 23 as the second member is moved up and down. However, the present invention is not limited to this. The second member may be moved back and forth, or may be rotated so that once the second member is moved over the target position, then moved to the target position to be aligned with the target position.

Incidentally, in this embodiment, the potentiometer 24 is used for detecting the moving position or amount of movement. However, this invention is not limited to this. An optical sensor such as a photo diode, or a rotation sensor may be used.

Further, this embodiment relates to the driving device 1 for driving the transportation member for such as CD or DVD, and aligning the receiving member, and used in the on-vehicle player 8. However, the present invention is not limited to this. The present invention is used for various applications.

Further, the present invention is especially effective when used in a driving device having a large mechanical error.

According to the embodiment described the above, the following driving device 1 and the on-vehicle player 8 are attained.

### (Note 1)

A driving device 1 including:

a receiving rack 10;

a conveyer 23 movable to the receiving rack 10 in both an arrow A direction and an arrow B direction which is a reverse direction against the arrow A direction;

a driving member 2 to move the conveyer 23; and

a controller 27 to control the driving member 2 to move the conveyer 23 to a target position of the receiving rack 10 in the arrow B direction after moving the conveyer 23 over the target position when the conveyer 23 is moved in the arrow A direction to align the conveyer 23 with the target position, and to control the driving member 2 to move the conveyer 23 to the target position without moving over the target position when the conveyer 23 is moved in the arrow B direction to align the conveyer 23 with the target position,

wherein after the conveyer 23 is moved over the target position and when the conveyer 23 is moved in the arrow B direction, the controller controls the conveyer 23 to move by a distance of a mechanical error at a time, and then to move intermittently to the target position for aligning the conveyer 23 with the target position.

### (Note 2)

The driving device 1 described in the note 1 further including:

a potentiometer 24 for detecting a position of the conveyer 23 relative to the receiving rack 10,

wherein the controller 27 controls the driving member 2 based on a divisional voltage V_{R} generated at a slider 24a of the potentiometer 24 indicating the position of the conveyer 23 detected by the potentiometer 24.

### (Note 3)

The driving device 1 as described in note 2,

wherein the controller 27 controls to move the conveyer 23 over the target position, then to continually actuate the driving member 2 until the divisional voltage V_{R} generated at the slider 24a of the potentiometer 24 indicating the position of the conveyer 23 detected by the potentiometer 24 is changed over a specific value to move the conveyer 23 by the distance of the mechanical error at a time.

### (Note 4)

An on-vehicle player 8 having the driving device 1 as described in any one of the note 1 to 3.

1. A driving device comprising:
a first member;
a second member movable to the first member in both one direction and the other direction which is a reverse direction against the one direction;
a driving member to move the second member; and
a controlling member to control the driving member to move the second member to a target position of the first member in the other direction after moving the second member over the target position when the second member is moved in the one direction to align the second member with the target position, and to control the driving member to move the second member to the target position without moving over the target position when the second member is moved in the other direction to align the second member with the target position,
wherein after the second member is moved over the target position and when the second member is moved in the other direction, the controller controls the second member to move by a distance of a mechanical error at a time, and then to move intermittently to the target position for aligning the second member with the target position.

2. The driving device as claimed in claim 1, further comprising:
a detecting member for detecting a position of the second member relative to the first member,
wherein the controlling member controls the driving member based on data indicating the position of the second member detected by the detecting member.

3. The driving device as claimed in claim 2,
wherein the controlling member controls to move the second member over the target position, then to continually actuate the driving member until the data indicating the position of the second member detected by the detecting member is changed over a specific value to move the second member by the distance of the mechanical error at a time.

4. An electronic apparatus having the driving device as claimed in any one of claims 1 to 3.
